(19) United States
(12) Patent Application Publication
(10) Pub. No.: US 2005/0002771 A1
(43) Pub. Date: Jan. 6, 2005

(54) Overturning device to overturn packs of folded sheet products

(75) Inventors: Mauro Gelli, Lucca (IT); Alessandro Morelli, Lucca (IT)

Correspondence Address: Breiner & Breiner, L.L.C., P.O. Box 19290, Alexandria, VA, 22320-0290, US

(73) Assignee: Fabio Perini S.p.A., Lucca (IT)

(21) Appl. No.: 10/876,556

(22) Filed: Jun. 28, 2004

(30) Foreign Application Priority Data
Jul. 1, 2003 (IT) FI2003A000182

(51) Int. Cl. B25J 1/00

(52) U.S. Cl. 414/758

(57) ABSTRACT

The device comprises a continuous member (31), to which a plurality of seats (23) are applied to hold packs (P2), which are transferred by the continuous organ along a path from a loading position (21X) of the packs to an unloading position (21Y) of the packs. Each seat comprises two walls (37A, 37B) movable with respect to each other, to retain the packs during the overturning movement. Moreover, opening members (63, 65A, 65B) are provided to cause the movable walls to withdraw reciprocally in the loading and unloading positions.

### TECHNICAL FIELD

The present invention relates to an overturning device to handle packs of folded sheet products, in particular packs of paper napkins or handkerchiefs.

The invention also relates to a folding machine, to produce folded sheet products, such as paper napkins or handkerchiefs, comprising an overturning device.

### STATE OF THE ART

To produce folded paper products, such as paper napkins or handkerchiefs made of tissue paper, folding machines are commonly used that fold a continuous web material (if necessary, previously folded in the longitudinal direction) in a zigzag configuration. The pack of web material folded in a zigzag configuration is then cut in half to produce two stacks of folded products, placed side by side to and symmetric with each other. The stacks of folded products are divided into individual packs each containing a predetermined number of folded products, which are then sent to a packing machine.

Examples of folding machines of this type are described in U.S. Pat. No. 6,120,240 and in WO-A-0214196.

In some cases half of the packs of folded products must be overturned, as they must all be fed to the packaging machine in the same direction, that is with the fold facing the same side. Overturning packs of products of this type is a complex operation, as the products are light and tend to form folds and to lose their orderly layout. The faster the overturning operations are and the higher the production speed of the folding machine is the more this problem is accentuated.

### OBJECTS AND SUMMARY OF THE INVENTION

The object of the present invention is to produce an overturning device which allows packs of products, in particular packs of napkins, handkerchiefs or other folded products produced with a sheet of tissue paper or another light material, to be overturned in a fast and reliable way.

Essentially, this and further objects and advantages—which shall be apparent to those skilled in the art by reading the text hereunder—are obtained in substance with an overturning device comprising a continuous member, applied to which is a plurality of seats to hold said packs, which are transferred by said continuous member along a path from a loading position of the packs to an unloading position of the packs, wherein each seat comprises two walls movable with respect to each other, and wherein opening members are provided in the loading and unloading position of the packs to cause reciprocal divarication of said movable walls.

With a device of this type, in the loading and unloading area, the opposed walls of each seat are temporarily divaricated to allow insertion of the packs and removal of the packs respectively. As soon as a pack has been inserted in the seat the continuous member can start to transfer the pack, overturning it, towards the unloading position, even at high speed, thanks to the fact that the two walls are moved closer to each other to mechanically retain the pack of products. The walls are then opened to allow unloading of the pack when the seat reaches the unloading position. In the path from the unloading position to the loading position the walls of the seat may remain open, although preferably they are reclosed, to simplify the opening and closing mechanism.

In a particularly advantageous embodiment of the invention, the continuous member has two essentially rectilinear portions, at the loading and unloading positions respectively. This allows linear acceleration of the seat wherein the pack of products has been inserted, even before the walls defining the seat have been completely reclosed. Analogously, in the unloading position the walls can open slightly in advance with respect to complete stop of the respective seats.

In a possible embodiment of the invention, the movable walls of each seat are elastically stressed towards each other in a position of maximum approach, and the opening members cause the walls to withdraw reciprocally against the elastic stress. For example, the opening members may comprise stops which are movable between an active position, wherein they interfere with one of the walls of said seat, and a deactivated position, withdrawn with respect to the path of the seats. When the opening members are in the active position they obstruct forward movement of one of the walls of said seat along the path defined by the flexible member, determining reciprocal divarication of said two walls with the forward movement of the flexible member.

In a possible embodiment of the invention, the device comprises a transferring member which transfers a row of packs coming from the folding machine directly to a delivery conveyor, while the packs of the adjacent row are inserted, by means of a delivery conveyor, into the seats of the overturning device. A removing member then removes each pack from the seats of the overturning device and deposits them on the delivery conveyor. In an advantageous embodiment, the transferring member and the removing member are produced identical to each other, to simplify the construction and obtain particular results in terms of versatility, which shall be explained hereunder.

Further advantageous characteristics and embodiments of the device according to the invention are indicated in the appended dependent claims.

### BRIEF DESCRIPTION OF THE DRAWINGS

The invention shall now be better understood by following the description and accompanying drawing, which shows a non-limiting practical embodiment of the invention. More specifically, in the drawing:

FIG. 1 shows a schematic side view of a line comprising a folding machine, a conveyor and an overturning device according to the invention, as well as a delivery conveyor;

FIG. 2 shows a front view according to II-II in FIGS. 1 and 3;

FIG. 3 shows a plan view according to III-III in FIG. 1;

FIG. 4 shows an enlargement of the front view of the overturning device;

FIG. 5 shows a partially sectional view according to V-V in FIG. 4;

FIGS. 6, 7 and 8 show local sections according to VI-VI, VII-VII and VIII-VIII in FIG. 5;

FIG. 9 shows a front view of the opening members;

FIG. 10 shows a section according to X-X in FIG. 9;

FIG. 11 shows a section according to XI-XI in FIG. 10;

FIG. 12 shows an enlarged view according to XII-XII in FIG. 2 of the removing member; and

FIGS. 13 and 14 show views according to XIII-XIII and XIV-XIV in FIG. 12.

### DETAILED DESCRIPTION OF THE PREFERRED EMBODIMENT OF THE INVENTION

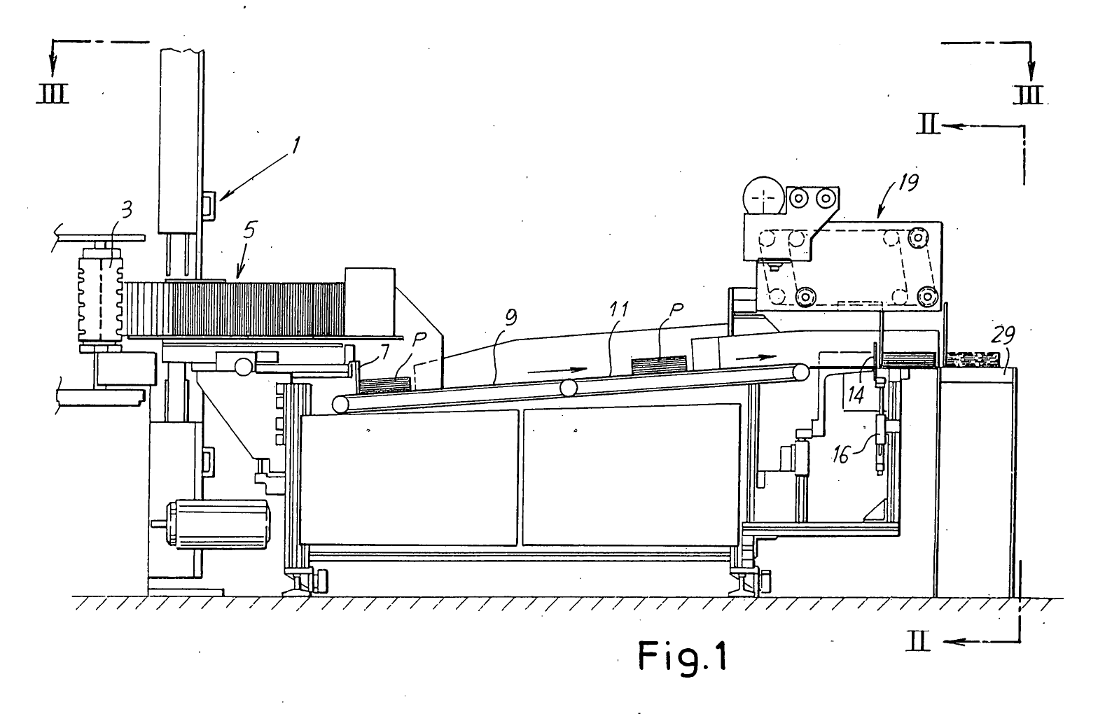

With initial reference to FIGS. 1 to 3, a production line for packs of folded products, such as napkins or the like, comprises a folding machine, indicated generically with 1, comprising two folding rollers 3. Disposed downstream of the folding rollers 3 is a transferring system 5 which transfers the packs of products, obtained by cutting the web material folded in a zigzag by the folding rollers 3, towards an unloading area. These elements are per se known and not described in greater detail herein. A detailed description is contained in U.S. Pat. No. 6,120,240 and in WO-A-0214196. In substance, two rows of packs of products, positioned side by side, are produced at the outlet of the folding machine, wherein the products are disposed symmetrically, that is, the folds of the products of one row are disposed in a symmetric way specularly with respect to the folds of the packs of the adjacent row.

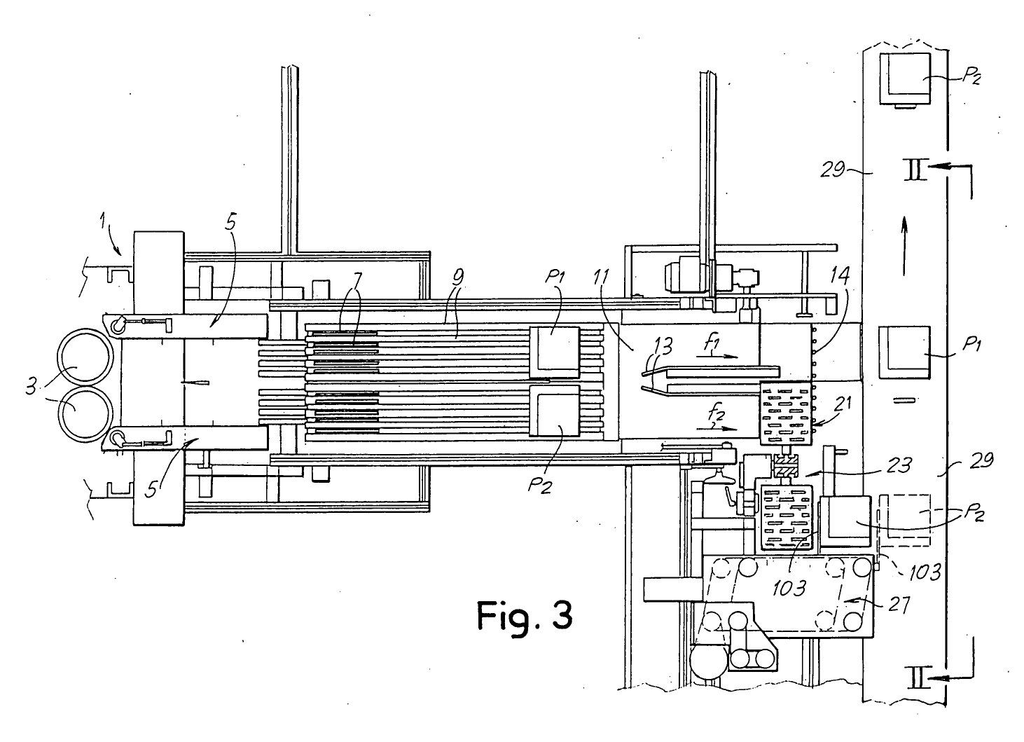

The packs P of folded products are unloaded by an unloading system 7 which places them in a horizontal position on a first conveyor 9, composed of a plurality of parallel belts. In the plan view in FIG. 3, P1 and P2 show two packs from one of the two side by side rows of packs delivered from the folding machine.

Disposed downstream of the conveyor 9 and in series therewith is a second conveyor 11, constituted in the example shown by continuous belt, which moves at a higher speed than the conveyor 9. The packs P of products are thus accelerated passing from one conveyor to the other. Disposed at the center of the conveyor 11 are members 13 to guide and separate packs of products placed side by side, which are disposed symmetrically with respect to the vertical median plane of the conveyor 11.

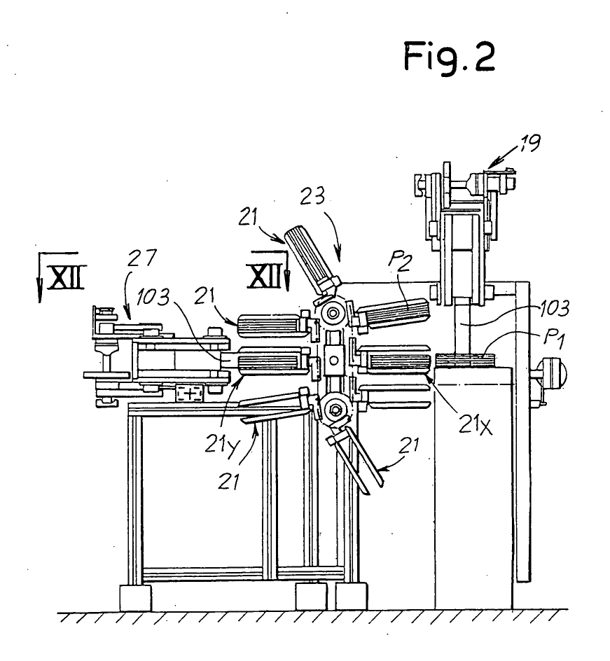

Packs of products P1 and P2 placed side by side move forward according to the arrows f1 and f2. The packs P1 which move forward according to the arrow f1 are carried by the conveyor 11 until they are under a transferring member 19 (FIGS. 1 and 2), while the single packs P2 are pushed by the conveyor 11 inside seats 21 of an overturning device, indicated as a whole with 23 and described in detail with reference to the figures hereunder. The seats 21, which are carried by a continuous member described hereunder defining a closed path, transfer the packs from the loading position, wherein the seat 21X in FIG. 2 is shown, to an unloading position, wherein the seat 21Y in FIG. 2 is shown. A removing member, indicated as a whole with 27, essentially identical to the transferring member 19, removes the single packs from the seats 21 when these pass through the unloading position 21Y, and places them on the delivery conveyor 29, onto which the packs P1 are transferred directly by the transferring member 19.

After being overturned by the overturning device 23 the packs P2 of the second row are disposed on the delivery conveyor 29 facing in the same direction as the packs P1 of the first row.

When it is unnecessary to overturn the packs, or when the packs are to be disposed symmetrically in the packages, the line may be simply modified by removing the overturning device 23 and mounting the removing member 27 side by side with the transferring member 19.

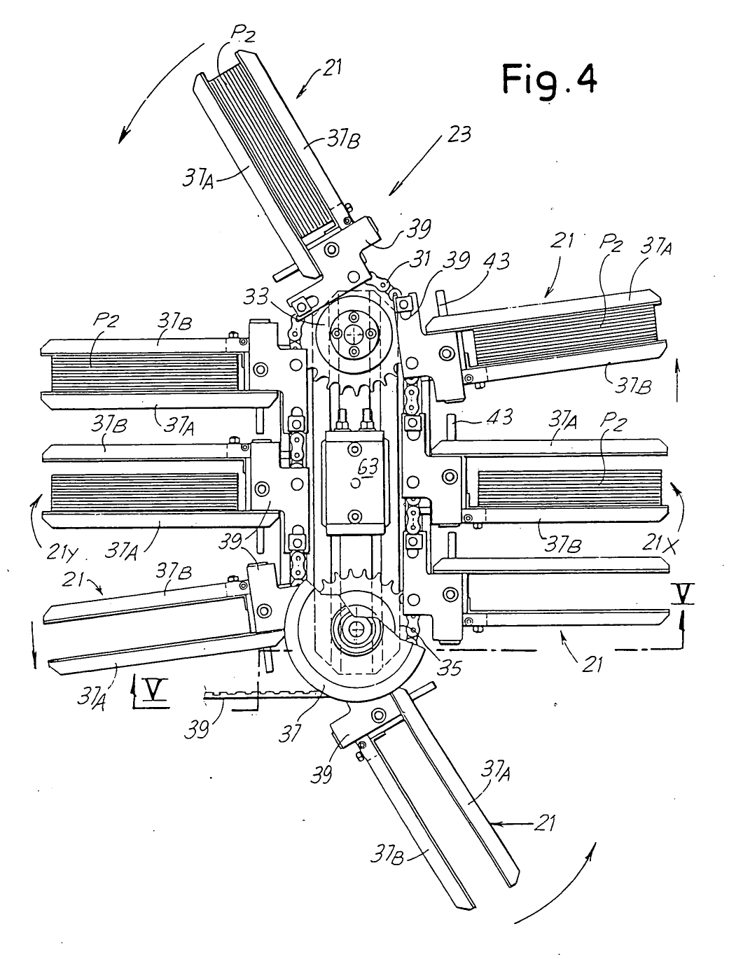

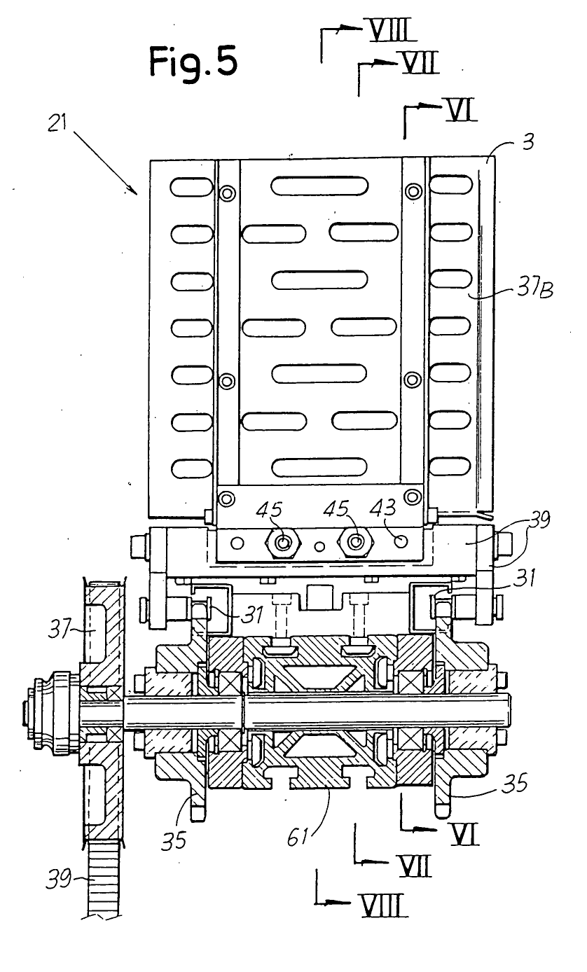

The overturning device 23 is shown in particular in FIGS. 4 to 8. It comprises a continuous member constituted by a pair of parallel chains 31 driven about two pairs of toothed chain wheels 33 and 35. The pair of toothed wheels 35 is motorized by means of a toothed belt 38, driven about a toothed pulley 37, coaxial with the chain wheels 35. In this way, the continuous member has two essentially rectilinear and parallel portions, along which the loading and unloading positions of the packs P2 of folded products are located, said positions being represented by the seats 21X and 21Y (FIG. 2 and FIG. 4).

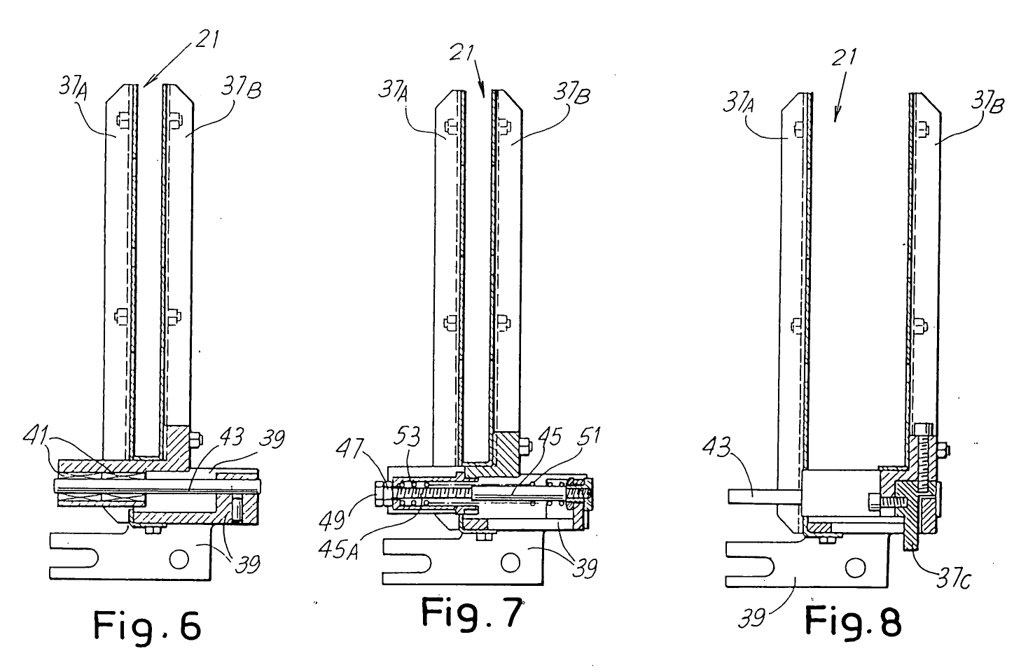

Each seat 21 is defined by two walls or blades 37A, 37B carried by respective bases 39 attached to the chains 31 forming the continuous member. As can be seen in particular in FIGS. 6 to 8, the wall 37A is rigidly attached to the base 39, while the wall 37B is movable with respect to the base. More specifically, the wall 37B of each seat is guided slidingly, by means of bearings 41 (FIG. 6) on guide rods 43 integral with the base 39. The guide rods 43 are orthogonal to the principal surface of the walls 37A, 37B and thus guide the wall 37B in a movement orthogonal to the plane on which the wall lies.

Moreover, two bars 45 are fixed to the base 39 of each seat 21, the distal portions 45A of which (that is, those farthest from the point attached to the base 39) are threaded and screwed onto each of which are a nut 47 and lock nut 49. Fitted around each bar 45 is a respective helical compression spring 51 which reacts between the base 39 and a bushing 53 integral with the wall 37B. Under the thrust of the helical springs 51 the bushings 53 come into contact with the nuts 47, which thus form limit stops defining the maximum approach position between the walls 37A and 37B. This maximum approach position is adjustable, so that when a pack of folded products is placed between the two walls, it is not over-compressed. FIGS. 6 and 7 show a condition wherein the stops are adjusted so that the wails 37A, 37B are in the position of minimum distance, corresponding to the minimum height of the packs to be handled. Differently, in FIG. 8 the movable wall 37B is in a position of maximum distance from the wall 37A.

As can be seen in particular in FIG. 4, the seats 21X and 21Y which are respectively in the loading and unloading positions, are in the open position, that is, with the walls 37A, 37B in the position of maximum distance (position in FIG. 8). Differently, the seats 21 between the unloading position 21Y and the position 21X are empty and therefore, due to the effect of the extension of the springs 51, their walls 37A, 37B are in the position of maximum approach (position in FIGS. 6 and 7). The seats 21 between the position 21X and the position 21Y, each of which contains a pack P2 of napkins, are in the partially closed condition, that is, with the walls 37B pushed, by the effect of the compression springs 51, towards the walls 37A and pressing against the pack P2 of folded products contained in the seat. In this way, the packs P2 are held firmly and stably in the seats, which may also be subject to relatively sudden accelerations, without the risk of breaking up the packs. Divarication between the walls 37A and 37B in the positions 21X and 21Y allows the packs to be inserted and unloaded without interference with the walls.

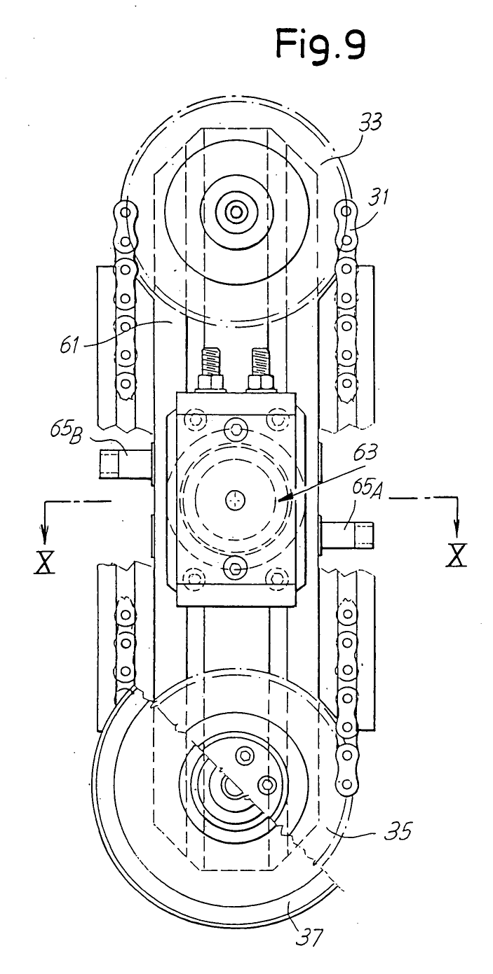

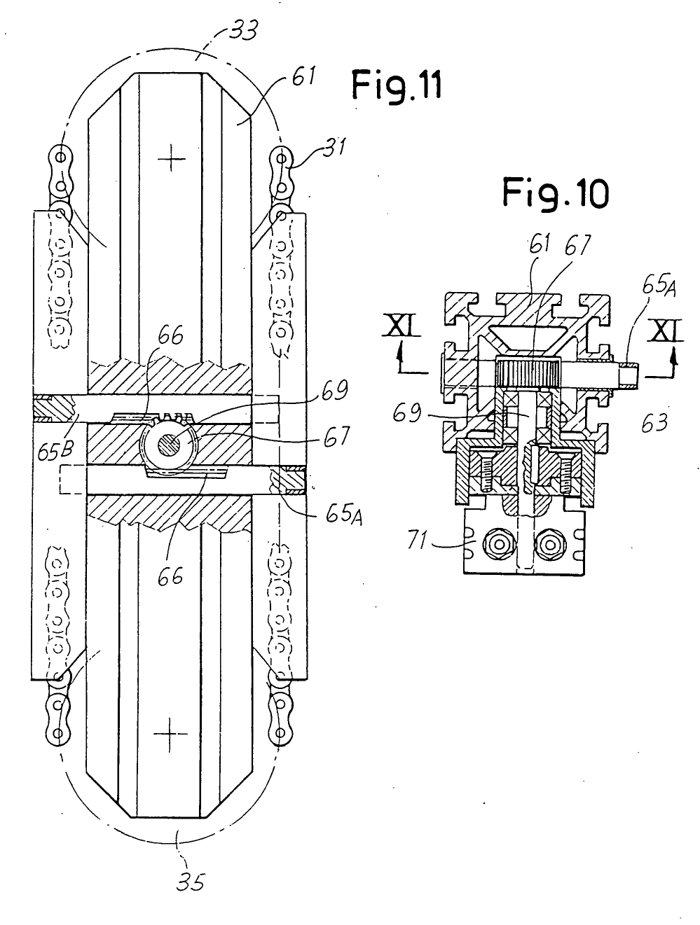

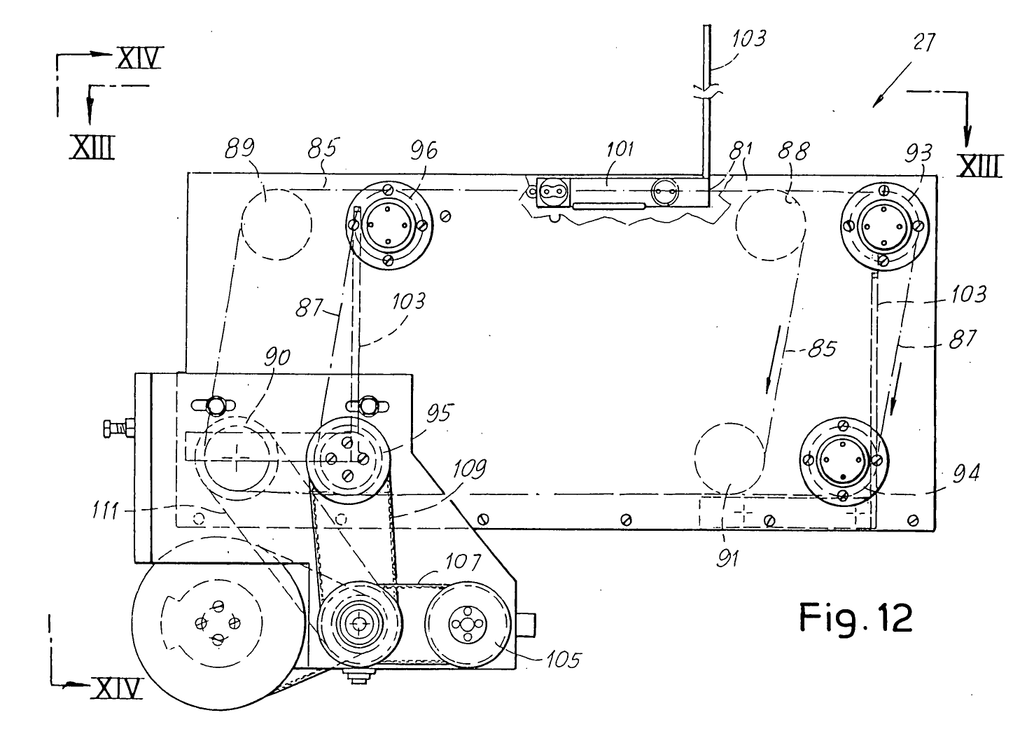

FIGS. 9, 10 and 11 show a possible and particularly advantageous mechanism to control opening of the seats 21 in the positions 21X and 21Y, that is, to divaricate the walls 37A and 37B. As can be seen in said Figures, a mechanism, indicated as a whole with 63, is fixed to a supporting structure 61 of the wheels 35, 37 and comprises two sliders 65A and 65B, which project from the mechanism 63 orthogonal to the rectilinear branches of the continuous member 31. The sliders 65A, 65B are equipped with toothed portions (FIG. 11) indicated with 66, meshing with which is a pinion 67, keyed onto a spindle 69 (FIG. 10) pivoting about its own axis. The pivoting movement of the spindle 69 is controlled by a rotating piston-cylinder actuator 71 or another suitable actuator. Rotation of the pinion 67 in one or other direction causes simultaneous protraction or retraction of the sliders 65A, 65B with respect to the sliding seat produced in the load-bearing structure 61. In FIG. 10 the sliders 65A and 65B are in the retracted position, while in FIGS. 9 and 11 they are in the protracted position.

As can be seen in particular in FIG. 11, when the sliders 65A, 65B are in the protracted position, they interfere with the trajectory of stops 37C integral with the movable walls 37B of each seat 21. Consequently, by protracting the sliders 65A, 65B, forward movement of the continuous member 31 brings the respective stops 37C of the walls 37B of the two seats 21 which are approaching the loading 21X and unloading 21Y positions against the sliders 65A, 65B. By continuing the travel of the continuous member 31 for a few millimeters after the stops 37C have come against the sliders 65A, 65B, this causes divarication of the walls 37A, 37B of the two seats 21 in the loading and unloading positions 21X and 21Y. Movement of the continuous member 31 is stopped when the compression springs 51 of the two seats in the positions 21X and 21Y are more or less in the condition of maximum compression. After the pack P2 has been inserted into the seat in position 21X and the pack P2 in the seat 21Y has been removed therefrom, the sliders 65A, 65B are retracted and the travel of the continuous member 31 starts up again.

FIGS. 9 to 11 show in particular the mechanism utilized in this embodiment to obtain divarication of the walls. This mechanism is particularly simple and reliable, although it must be understood that other mechanisms would be possible. Hypothetically, it would even be possible to use an actuator on each seat 21, for example a pneumatic piston, with a suitable rotating distributor of the working fluid, or with a coupling for the working fluid only in the positions 21X and 21Y.

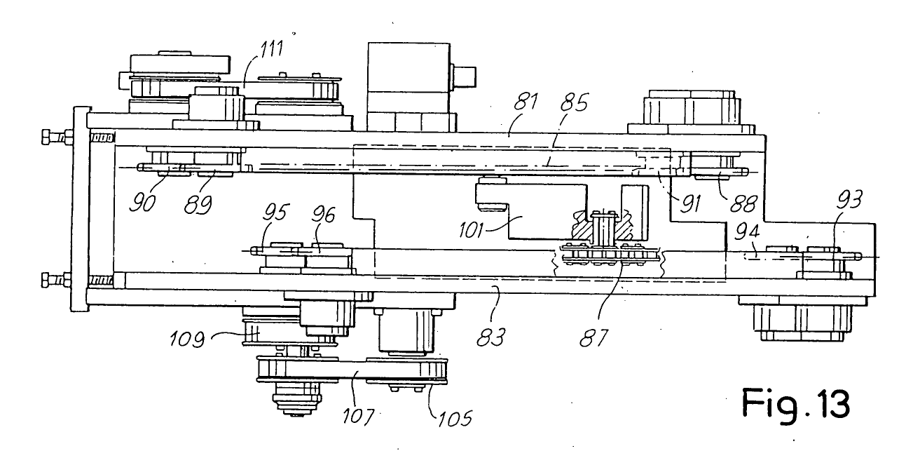

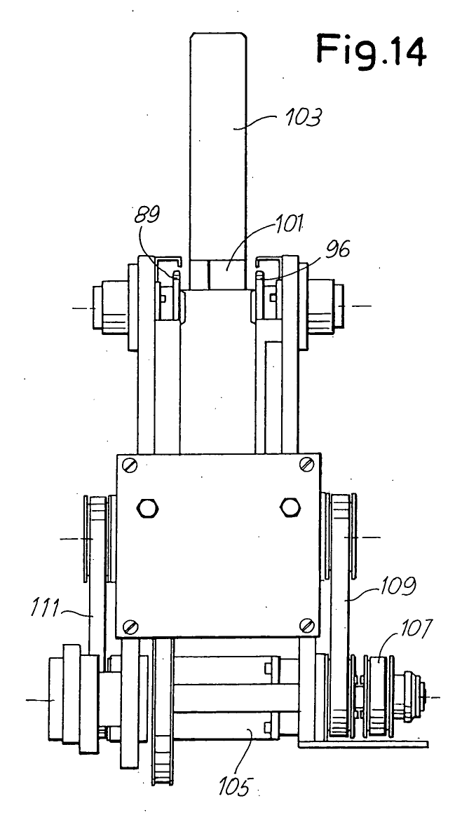

FIGS. 12 to 14 show the removing member 27, the structure of which (as indicated hereinbefore) is essentially identical to the structure of the inserting member 19. Disposed between the two sides 81, 83 are two chains 85, 87 parallel to each other, extending according to two closed paths, identical although spatially staggered. The chain 85 is driven around toothed wheels 88, 89, 90, 91 carried by the side 81, while the chain 87 is driven around toothed wheels 93, 94, 95 and 96 carried by the side 83.

Engaged with the two chains 85, 87 are sliders 101, fixed rigidly to which are pushers 103 in the form of long and narrow blades, the width of which is such that they may be inserted between the divaricated walls 37A, 37B of each seat 21 of the overturning device 23. With the particular layout of the chains 85, 87 a translatory movement of the pushers 103 parallel to each other is obtained along a path of development corresponding to the path of the chains. The movement is controlled by a motor 105 by means of toothed pulleys 107, 109 and 111.

Operation of the device described is as follows.

The folding machine 1, the transferring device 5 and the unloading system 7 produce and place on the conveyor 9 packs of folded products disposed in symmetric rows of packs P1 and P2. The conveyor 9 transfers the packs to the conveyor 11, which accelerates them and further transfers them towards the delivery conveyor 29, which may form part of a packaging machine. In practice, each pack P1 of the first row of packs is pushed by the conveyor 11 against a movable vertical stop 14 actuated by a piston-cylinder actuator 16. The stop is extracted above the surface of forward movement of the packs and stops a pack P1. Subsequently, the stop is lowered to allow the pusher of the removing member 19 (analogous to the member 27) to push the pack onto the delivery conveyor 29. In FIGS. 1 and 3 three packs coming from the row of packs P1 can be seen: one of the packs is already on the delivery conveyor 29, one is in position to be transferred from the pusher of the member 19, while the third is against the stop 14. The delivery conveyor 29 transports the single packs to the packaging area (not shown).

The packs P2 of the second row are pushed one at a time from the conveyor 11 into the seats 21 as they arrive at the loading position 21X. A stop analogous to the stop 14 may be utilized to stop the packs in the correct position inside the seat 21 time by time in the position 21X. In this position, by the effect of the slider 65A the walls 37A, 37B of the seat 21X are held divaricated to allow insertion of the pack P2 of folded products.

Each pack P2 inserted in the respective seat 21 is retained therein taking the walls 37A, 37B to the closed position by retracting the slider 65A. Then, with a stepped movement of the overturning device 23, this pack is transferred to the unloading position 21Y. Here, by means of the slider 65B the walls 37A, 37B of the seat 21Y are opened. This allows one of the pushers 103 of the removing member 27 to push the pack P2 out of seat 21 onto the delivery conveyor 29.

When the packs P2 do not require to be overturned, the removing member 27 is disassembled and mounted side by side with the member 19, to perform the function of transferring the packs P2, without overturning, directly onto the delivery conveyor 29, with analogous methods to those described hereinbefore with reference to the member 19.

In order to facilitate removal of each pack P2 from the seat 21 of the overturning device, the lower edge of each of the pushers or blades 103 may be provided with a rubber strip, which rubs on the inner surface of the lower wall 37A of the respective seat. This prevents the lower product(s) of each pack from remaining inside the seat. Alternatively to the rubber strip a suitable configuration of the inner surface of the wall 37A may be provided, for example with a groove parallel to the direction wherein the packs of products are removed. In a complementary way, the pusher or blade 103 will in this case have a tooth that penetrates the groove.

It is understood that the drawing purely shows a practical embodiment of the invention, which may vary in forms and layouts without however departing from the scope of the concept on which the invention is based. Any reference numbers in the appended claims have the sole purpose of facilitating reading in the light of the description hereinbefore and of the accompanying drawings and do not limit the scope of protection whatsoever.

1. An overturning device to overturn packs of folded sheet products, comprising a continuous member, applied to which are a plurality of seats to retain said packs, which are transferred by said continuous member along a path from a loading position of the packs to an unloading position of the packs, wherein each seat comprises two walls movable with respect to each other, and wherein opening members are provided to cause said movable walls to withdraw reciprocally.

2. Device as claimed in claim 1, wherein said opening members are disposed at the level of said loading and unloading positions.

3. Device as claimed in claim 1, wherein said continuous member has two essentially rectilinear portions, respectively at said loading and unloading positions.

4. Device as claimed in claim 2, wherein said continuous member has two essentially rectilinear portions, respectively at said loading and unloading positions.

5. Device as claimed in claim 3, wherein said rectilinear portions are vertical.

6. Device as claimed in claim 1, wherein said movable walls are elastically stressed against each other in a position of maximum approach, said opening members causing said walls to withdraw reciprocally against the elastic stress.

7. Device as claimed in claim 2, wherein said movable walls are elastically stressed against each other in a position of maximum approach, said opening members causing said walls to withdraw reciprocally against the elastic stress.

8. Device as claimed in claim 3, wherein said movable walls are elastically stressed against each other in a position of maximum approach, said opening members causing said walls to withdraw reciprocally against the elastic stress.

9. Device as claimed in claim 4, wherein said movable walls are elastically stressed against each other in a position of maximum approach, said opening members causing said walls to withdraw reciprocally against the elastic stress.

10. Device as claimed in claim 6, wherein said opening members comprise sliders movable from an active position, wherein they interfere with one of the walls of said seat, and a deactivated position, withdrawn with respect to the path of said seats, in the active position obstructing forward movement of one of the walls of said seat along the path defined by said flexible member, causing reciprocal divarication of said two walls with the forward movement of the flexible member.

11. Device as claimed in one or more of the previous claims, wherein two sliders are disposed in an intermediate position along the closed path of said continuous member, sliding orthogonal to two essentially parallel portions of said flexible member, with an actuator which controls sliding, simultaneous and in opposed directions, of said two sliders.

12. Device as claimed in one or more of claims 1 to 10, comprising a transferring member which transfers the packs of a row directly onto a delivery conveyor, and a removing member which removes the packs coming from a second row and which are inserted into the seats of the overturning device, from said seats to the unloading position and transfers them to the delivery conveyor.

13. Device as claimed in claim 12, wherein said transferring member and said removing member are essentially identical to each other.

14. Device as claimed in claim 12, wherein said inserting member and/or said removing member comprise a pair of continuous flexible elements disposed according to two identical and staggered paths, attached to which are pushers, which are made to translate by said continuous flexible members along closed paths.

15. A folding machine for producing folded products in sheets, comprising a folding section, a system to transport packs of folded products and a device as claimed in one or more of claims 1 to 10.

16. Folding machine as claimed in claim 11, wherein said transport system comprises at least a pair of conveyors disposed in series and activated at different speeds from each other.
